(19) United States
(12) Patent Application Publication
(10) Pub. No.: US 2025/0029138 A1
(43) Pub. Date: Jan. 23, 2025

(54) MULTI-COMPANY LOYALTY POINT MANAGEMENT DEVICE AND METHOD

(71) Applicant: Toshiba Tec Kabushiki Kaisha, Tokyo (JP)

(72) Inventor: Yoshihiro KARITA, Izunokuni Shizuoka (JP)

(21) Appl. No.: 18/767,695

(22) Filed: Jul. 9, 2024

(30) Foreign Application Priority Data
Jul. 20, 2023 (JP) 2023-118535

(51) Int. Cl. G06Q 30/0226

(52) U.S. Cl. CPC G06Q 30/0229; G06Q 30/0233

(57) ABSTRACT

According to an embodiment, a point management device for a multi-store commercial facility includes a processor and a communication interface to connect to a plurality of payment terminals in a plurality of stores of the facility. The processor acquires a notification of points granted to a member of a loyalty program for a transaction at a payment terminal in the plurality payment terminals, updates the points of the member based on the notification, and determines if the points of the member satisfy a benefit granting condition. When the points satisfy the benefit granting condition, the processor sends a benefit provision notification to the payment terminal if the payment terminal is a first-type terminal but not if the payment terminal is a second-type terminal.

### CROSS-REFERENCE TO RELATED APPLICATION

This application is based upon and claims the benefit of priority from Japanese Patent Application No. 2023-118535, filed Jul. 20, 2023, the entire contents of which are incorporated herein by reference.

### FIELD

Embodiments described herein relate to a multi-company loyalty point management device and a point management method for multi-store commercial facilities and the like.

### BACKGROUND

A multi-store commercial facility or complex, such as a shopping center, a shopping mall, or the like, may introduce a point service (e.g., a customer loyalty reward service) for multiple stores operating therein. After the point service is introduced, customers who have joined the point service (referred to as point members) can earn points each time they purchase merchandise or services from those stores directly operated by the parent company of the facility (referred to as a facility management company) as well as tenant stores of the facility that may be operated by other companies. Earned points are accumulated by each customer (point member), and when a predetermined number of points is reached, the points can be, for example, exchanged for a coupon that can be used at the stores within the facility or otherwise.

In such an operation, it is preferable to dispense the complimentary coupon using a receipt printer in a payment machine at any of the stores. However, the payment machines at the various stores are not necessarily all from the same device manufacturer. Therefore, a payment machine only at a directly managed store may be capable of dispensing the complimentary coupon, and the payment machines at a tenant store may not be capable of dispensing a complimentary coupon. In view of this complexity, there is a need for a point management device that can easily introduce a point service in such multi-store commercial facilities.

### BRIEF DESCRIPTION OF THE DRAWINGS

FIG. 1 depicts a point management system in a complex commercial facility with a point service.

FIG. 2 is a block diagram of a payment machine.

FIG. 3 is a block diagram of a point management server.

FIG. 4 is a schematic diagram of a member record stored in a member database.

FIG. 5 is a schematic diagram of a benefit record stored in a benefit database.

FIG. 6 is a schematic diagram showing a data structure of a store table.

FIG. 7 is a flowchart of information processing executed by a processor of a point management server.

FIG. 8 depicts an example of a complimentary coupon.

FIG. 9 is a flowchart of information processing executed by a processor of a point management server.

FIG. 10 is a flowchart of information processing executed by a processor of a point management server in a second embodiment.

FIG. 11 depicts an example of an inquiry screen.

### DETAILED DESCRIPTION

Certain embodiments concern the provision of a point management device that can more efficiently implement and manage a point service in a commercial facility with multiple stores with different ownership and/or in-store point-of-sale systems.

According to one embodiment, a point management device for a multi-store commercial facility, the device including a communication interface configured to connect to a plurality of payment terminals in a plurality of stores and a processor. The processor is configured to acquire notification of points granted to a member of a loyalty program for a transaction at a payment terminal in the plurality payment terminals, update the points of the member based on the notification, determine if the points of the member satisfy a benefit granting condition, and, when the points satisfy the benefit granting condition, send a benefit provision notification to the payment terminal if the payment terminal is a first-type terminal but not if the payment terminal is a second-type terminal.

Hereinafter, certain example embodiments of a point management device for a commercial facility will be described with reference to the drawings.

An example embodiment describes a case in which a point service is introduced in a commercial facility that includes both stores directly managed by a parent company of the facility and tenant stores managed by other companies. Specifically, it is assumed in this example that customers who are point members can earn points not only by purchases at the directly managed stores but also at the tenant stores. The earned points are accumulated for each customer, and when a predetermined number of points is reached, the points can be exchanged for a benefit such as a complimentary coupon that can be used at the stores within the facility. The coupon may be for a price reduction, a discount, or other benefit. However, the complimentary coupon can be dispensed from a payment machine only of a directly managed store. The payment machines in the tenant stores do not have the function of dispensing the complimentary coupons. The present embodiment exemplifies a case where such a point service is introduced into a shopping mall. Hereinafter, a customer who is a point member is referred to as a member.

### First Embodiment

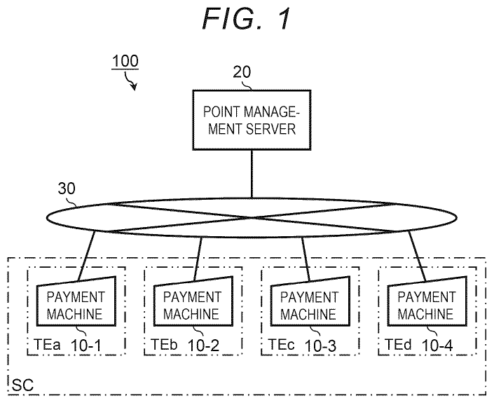

First, a first embodiment will be described with reference to FIGS. 1 to 9.

### Schematic Description of Point Management System

FIG. 1 is a schematic configuration diagram of a point management system 100 constructed in a commercial facility SC to introduce a point service. The point management system 100 includes a point management server 20 and a communication network 30. The point management server 20 and a plurality of payment machines 10 (10-1, 10-2, 10-3, 10-4, etc.) are connected to the communication network 30. The communication network 30 is a wide area network that allows data communication between the payment machines 10 and the point management server 20. For example, a computer network such as the Internet or an intranet can be used as the communication network 30. A mobile communication network may be used as a part of the communication network 30.

The payment machines 10 are installed in different stores TE (TEa, TEb, TEc, TEd, etc.) in the commercial facility SC. These stores TE include a directly managed store (first-type store) operated by a parent company of the commercial facility SC and a tenant store (second-type store) operated by another company. The business category of the stores TE is not particularly limited. The stores may be a retail store that sells merchandise, a restaurant that provides food and drink, or a store that provides services such as a movie theater or a sports gym. The total number of the payment machines 10 installed in the stores TE is not particularly limited. In general, only one payment machine 10 need be installed in each store TE, but, of course, two or more payment machines 10 may be installed in each store TE. The payment machine 10 is a point of sales (POS) terminal. The POS terminal may be a face-to-face POS terminal operated by a store clerk or may be a self-service POS terminal operated by a customer.

The point management server 20 is a server computer specialized for operation and management of the point service introduced in the commercial facility SC. The point management server 20 is an aspect of the point management device according to the embodiment. The point management server 20 is installed, for example, in a data center of the commercial facility SC. In some examples, point management server 20 may be provided on a cloud service via the Internet.

### Configuration Description of Payment Machine

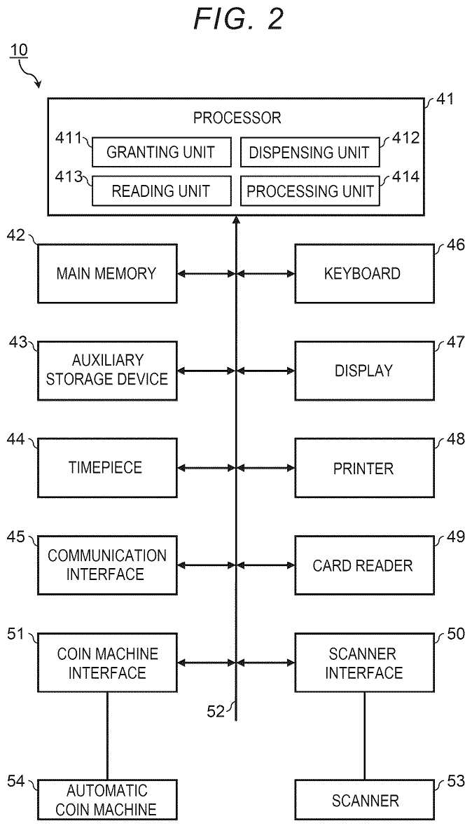

The payment machines 10 installed in the stores TE are not necessarily of the same model. The payment machines 10 may be from different manufacturers or of different models from the same manufacturer may. However, as a general matter, the basic configuration of the payment machines 10 are the same. The basic configuration of the payment machine 10 will be described with reference to FIG. 2.

FIG. 2 is a block diagram showing the basic configuration of a payment machine 10. The payment machine 10 includes a processor 41, a main memory 42, an auxiliary storage device 43, a timepiece 44, a communication interface 45, keyboard 46, a display 47, a printer 48, a card reader 49, a scanner interface 50, a coin machine interface 51, and a system transmission path 52. The system transmission path 52 includes an address bus, a data bus, a control signal line, and the like. The system transmission path 52 connects the processor 41 and other units, and transmits data signals exchanged therebetween.

The payment machine 10 comprises a computer connecting the processor 41, the main memory 42, the auxiliary storage device 43, the timepiece 44, and the communication interface 45 through the system transmission path 52. Input/output devices such as the keyboard 46, the display 47, the printer 48, and the card reader 49, and device interfaces such as the scanner interface 50 and the coin machine interface 51 are connected to the system transmission path 52 and controlled for implementing the function of the payment machine 10. The input/output device and the device interface connected to the system transmission path 52 are not limited to those described above. For example, another input/output device such as a touch panel or a customer display may be connected, or a device interface for a cashless settlement terminal may be connected.

The processor 41 corresponds to a central part of the computer. The processor 41 controls each unit to implement various functions of the payment machine 10 according to an operating system or an application program. The processor 41 is, for example, a central processing unit (CPU).

The main memory 42 corresponds to a main storage part of the computer. The main memory 42 includes a nonvolatile memory area and a volatile memory area. The main memory 42 stores an operating system or an application program in the nonvolatile memory area. The main memory 42 may store data necessary for the processor 41 to execute processing for controlling each unit in the nonvolatile or volatile memory area. In the main memory 42, the volatile memory area is used as a work area where data is rewritten as appropriate by the processor 41. The nonvolatile memory area is, for example, a read only memory (ROM). The volatile memory area is, for example, a random access memory (RAM).

The auxiliary storage device 43 corresponds to an auxiliary storage part of the computer. For example, the auxiliary storage device 43 may be an electric erasable programmable read-only memory (EEPROM), a hard disk drive (HDD), a solid state drive (SSD), or the like. The auxiliary storage device 43 stores data used by the processor 41 in performing various types of processing, data generated by the processing in the processor 41, and the like. The auxiliary storage device 43 may store an application program.

The timepiece 44 tracks a date and time. The processor 41 processes the date and time tracked by the timepiece 44 as a current date and time.

The communication interface 45 is an interface for performing data communication with the point management server 20 or the like connected to the communication network 30.

The keyboard 46 is, for example, an input device in which various keys necessary for registration of purchased merchandise and settlement of transactions are incorporated. The display 47 is an output device for displaying, for example, a merchandise name, a price, and a total amount of a registered purchased merchandise. The printer 48 is an output device for printing data on receipt paper and dispensing purchase receipts or the like. The card reader 49 is an input device for reading card data such as a point card and a credit card.

The scanner is an interface 50 interface for performing data communication with a scanner 53. The scanner 53 is a device that optically scans and reads a code such as a barcode or a two-dimensional code. The scanner 53 may be a stationary scanner or a handheld scanner.

The coin machine interface 51 is an interface for performing data communication with an automatic coin machine 54. The automatic coin machine 54 has a function of counting cash of banknotes or coins inserted through an insertion port and storing the cash in the safe by denomination, and a function of extracting cash equivalent to coins from the safe and dispensing the cash to a dispensing port. A drawer may be connected instead of the automatic coin machine.

Among the payment machines 10 having such a basic configuration, the payment machines 10 installed in a directly managed store have the functions provided by the processor 41 of a granting unit 411, a dispensing unit 412, a reading unit 413, and a processing unit 414. On the other hand, in the payment machines 10 installed in a tenant store, the processor 41 provides the functions of a granting unit 411, a reading unit 413, and a processing unit 414, but not the function of a dispensing unit 412. In the following description, a payment machine 10 installed in a directly managed store and providing the functions of a dispensing unit 412 is referred to as a “first payment machine 101,” and a payment machine 10 installed in a tenant store and lacking the functions of a dispensing unit 412 is referred to as a “second payment machine 102.” Here, the first payment machine 101 corresponds to a terminal of a first store and the second payment machine 102 corresponds to a terminal of a second store.

The granting unit 411 provides a function of granting points to a member according to a transaction with the member at the time the transaction is settled. For example, when the card reader 49 reads data of a point card, the granting unit 411 acquires a member ID of the member. When the transaction with the member is settled by the operation input of the scanner 53, the keyboard 46, or the display 47, the granting unit 411 derives (e.g., calculates) the points to be granted (the granted points). The granted points can be variable values and may calculated based on the transaction amount or the like. The granted points may be a fixed value that is granted each time a transaction is settled. When the granted points are derived, the granting unit 411 notifies the point management server 20 of a granting event. The granting event notice includes a store ID, a payment machine ID, a transaction number, and the like in addition to the granted points and the member ID. The store ID is unique identification information assigned to each store TE whether a directly managed store or a tenant store in the commercial facility SC. The payment machine ID is unique identification information assigned to each payment machine 10 installed in each store TE. The transaction number can be a serial number or the like issued each time a transaction is settled by a payment machine 10.

The dispensing unit 412 provides a function of dispensing a complimentary coupon, which is a benefit, to a member whose held point value satisfies a benefit provision condition. The dispensing unit 412 dispenses a complimentary coupon such as a price reduction coupon, a discount coupon, or a product coupon that can be used in any store TE in the commercial facility SC. The complimentary coupon is printed on receipt paper by the printer 48 and dispensed to the customer.

The reading unit 413 provides a function of reading identification information of the complimentary coupon. A benefit code is set as identification information unique to each complimentary coupon dispensed by a dispensing unit 412, and a barcode indicating (e.g., encoding) the benefit code is printed on the dispensed coupon. The reading unit 413 reads the barcode via the scanner 53 and outputs data of the barcode to the point management server 20.

The processing unit 414 provides a function of executing complimentary processing using the identification information read by the reading unit 413, that is, the complimentary coupon identified by the benefit code. For example, if the complimentary coupon is a price reduction coupon, the processing unit 414 reduces a transaction amount by the price reduction amount of the price reduction coupon. For example, if the complimentary coupon is a discount coupon, the processing unit 414 discounts the transaction amount by the discount rate (percentage) of the discount coupon. For example, if the complimentary coupon is a product coupon or voucher, the processing unit 414 changes the applied price for the product (merchandise) to which the coupon by the coupon value or the like, and re-calculates the transaction subtotal amount. The processing related to the price reduction coupon, the discount coupon, or the product coupon are each an example of the complimentary processing.

### Configuration Description of Point Management Server

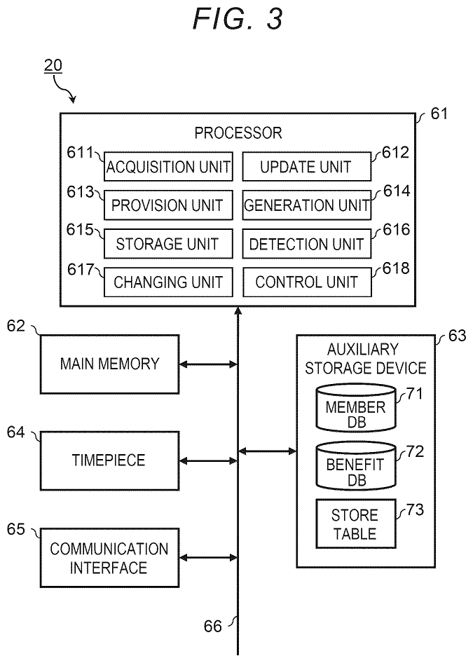

FIG. 3 is a block diagram of the point management server 20. The point management server 20 includes a processor 61, a main memory 62, an auxiliary storage device 63, a timepiece 64, a communication interface 65, a system transmission path 66, and the like. The system transmission path 66 includes an address bus, a data bus, a control signal line, and the like. The system transmission path 66 connects the processor 61 and other units and transmits data signals exchanged therebetween.

The point management server 20 comprises a computer by connecting the processor 61, the main memory 62, the auxiliary storage device 43, the timepiece 64, and the communication interface 65 through the system transmission path 66.

The processor 61 corresponds to a central part of the computer. The processor 61 controls each unit to implement various functions of the point management server 20 according to an operating system or an application program. The processor 61 is, for example, a CPU. The processor 61 is preferably a multi-core processor that includes a plurality of processor cores and can execute a plurality of processes in parallel.

The main memory 62 corresponds to a main storage part of the computer. The main memory 62 includes a nonvolatile memory area and a volatile memory area. The main memory 62 stores an operating system or an application program in the nonvolatile memory area. The main memory 62 may store data necessary for the processor 61 to execute processing for controlling each unit in the nonvolatile or volatile memory area. In the main memory 62, the volatile memory area is used as a work area where data is rewritten as appropriate by the processor 61. The nonvolatile memory area is, for example, a ROM. The volatile memory area is, for example, a RAM.

The auxiliary storage device 63 corresponds to an auxiliary storage part of the computer. For example, an EEPROM, an HDD, or an SSD may serve as the auxiliary storage device 63. The auxiliary storage device 63 stores data used by the processor 61 in performing various types of processing, data generated by the processing in the processor 61, and the like. The auxiliary storage device 63 may store an application program.

The timepiece 64 tracks a date and time. The processor 61 processes the date and time tracked by the timepiece 64 as a current date and time.

The communication interface 65 is an interface for performing data communication with the plurality of payment machines 10 connected to the communication network 30.

In the point management server 20 having such a configuration, a part of a storage area in the auxiliary storage device 63 is used as an area for a member database 71, a benefit database 72, and a store table 73.

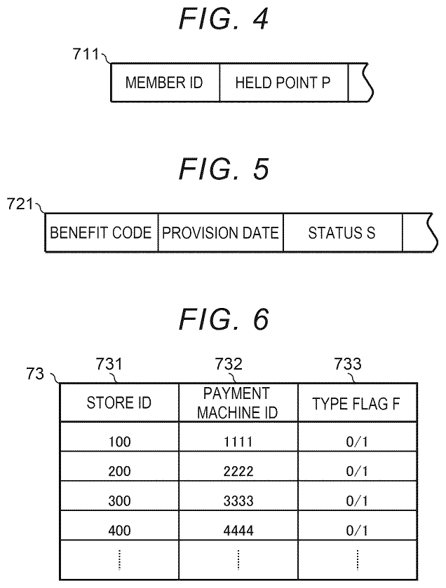

The member database 71 is a collection of member records 711 (see FIG. 4) generated for each member. FIG. 4 shows main data items constituting the member record 711. As illustrated, the member record 711 includes items of a member ID and a held point P.

When a user becomes a member of the point service of the commercial facility SC, a unique member ID is assigned to the member. Then, a member record 711 including the member ID is generated and registered in the member database 71.

Incidentally, a point card with a member ID recorded is issued to the member. The point card is, for example, a magnetic card. The point card may be a contact type or non-contact type IC card. The member can set the member ID in a point application by installing application software compatible with the point service, that is, a point application in a smartphone or the like, and registering as a member. In this case, when the point application is activated, a barcode or a two-dimensional code indicating the member ID is displayed on a display of the smartphone. The member can receive points by presenting the smartphone on which the barcode or two-dimensional code indicating a point card or a member ID is displayed when a transaction is settled at the directly managed store or tenant store of the commercial facility SC.

The benefit database 72 is a set of benefit records 721 (refer to FIG. 5) generated for each complimentary coupon which is a benefit. FIG. 5 shows main data items constituting the benefit record 721. As illustrated, the benefit record 721 includes a benefit code, a provision date, a status S, and the like. The benefit code is a unique code set for each complimentary coupon so as not to overlap. That is, the benefit code functions as identification information of the benefit. The provision date is a date on which a complimentary coupon is dispensed. The complimentary coupon has a validity period. The provision date is used to calculate the validity period. The status S is information indicating a usage status of the complimentary coupon. The complimentary coupon has two usage statuses: unused and used. In other words, the status before the complimentary coupon is used for reducing or discounting a transaction amount is unused, and the status after use is used. In the present embodiment, the status S indicating the unused status is set to “0”, and the status S indicating the used status is set to “1”.

As shown in FIG. 6, the store table 73 is a data table including a column 731 for the store ID, a column 732 for the payment machine ID, and a column 733 for a type flag F. A unique store ID assigned to each store TE is in the column 731. The payment machine ID of the payment machine 10 installed in the store TE specified by the store ID in the column 731 is in the column 732. The type flag F is in the column 733. The type flag F is 1-bit data (flag data) for identifying whether the payment machine 10 matching the payment machine ID in the column 732 is a first payment machine 101 (providing a dispensing unit 412) or a second payment machine 102 (not providing a dispensing unit 412). In the present embodiment, the type flag F value for identifying the first payment machine 101 is set to “1”, and the type flag F value for identifying the second payment machine 102 is set to “0”. Therefore, the type flag F associated with the payment machine ID of a first payment machine 101 installed in a directly managed store is “1”. The type flag F associated with the payment machine ID of a second payment machine 102 installed in a tenant store is “0”.

### Returning to the Description of FIG. 2

The processor 61 provides functions of an acquisition unit 611, an update unit 612, a provision unit 613, a generation unit 614, a storage unit 615, a detection unit 616, a changing unit 617, and a control unit 618 to enable introduction of the point service in the commercial facility SC. The functions of the processor 61 are not limited thereto.

The acquisition unit 611 provides a function of acquiring points granted to a member from a first payment machine 101 and a second payment machine 102. As described above, the first payment machine 101 and the second payment machine 102 both include a granting unit 411 that notifies the point management server 20 of a granting event. The acquisition unit 611 thus acquires the member ID and the granted point from the granting event sent from the first payment machine 101 or the second payment machine 102.

The update unit 612 provides a function of updating the held points of a member with the points acquired by the acquisition unit 611. The point management server 20 includes the member database 71. The update unit 612 adds the newly granted points, as acquired by the acquisition unit 611, to the held point P of the member record 711 for the member ID acquired by the acquisition unit 611.

The provision unit 613 provides a function of providing a benefit to a member whose held point P value satisfies a benefit provision condition while at a first payment machine. As described above, the first payment machine 101 is one that includes or provides a dispensing unit 412. In cooperation with a dispensing unit 412, the provision unit 613 dispenses a complimentary coupon to the member whose held point P value satisfies a benefit provision condition.

The possible benefit provision conditions is not particularly limited. In the present example, the benefit provision condition is set to “a price reduction coupon of 500 yen is dispensed each time the held point P reaches 500 points”. That is, the provision unit 613 dispenses one price reduction coupon of 500 yen to the member whose held point P value reaches at least 500 points. For example, for a member whose held point P value reaches 1000 points, the provision unit 613 dispenses two price reduction coupons of 500 yen apiece.

The generation unit 614 generates identification information for each benefit provided by the provision unit 613. A unique benefit code is assigned as identification information to a complimentary coupon which is dispensed. The generation unit 614 generates a benefit code, which is identification information of the complimentary coupon, each time the provision unit 613 dispenses the complimentary coupon in cooperation with the dispensing unit 412.

The storage unit 615 provides the function of storing, in association with the identification information generated by the generation unit 614, the usage status of the benefit identified by the identification information. The point management server 20 includes the benefit database 72. Each time a benefit code is generated by the generation unit 614, the storage unit 615 stores a benefit record 721 including the benefit code, a date tracked by the timepiece 64 (provision date), and a status S value (initially indicating an unused status) in the benefit database 72.

The detection unit 616 provides a function of detecting a benefit code in data received from the first payment machine 101 or the second payment machine 102. As described above, the first payment machine 101 and the second payment machine 102 both include a reading unit 413. The detection unit 616 detects the benefit code in barcode data output to the point management server 20 via the communication network 30 by the operation of the reading unit 413.

The changing unit 617 provides the function of changing the usage status of the benefit (benefit code) detected by the detection unit 616 from unused to used. That is, the changing unit 617 changes the status S value in the benefit record 721 matching the benefit code detected by the detection unit 616 from “0” (indicating unused) to “1” (indicating used).

The control unit 618 permits use of a benefit (benefit code) when the usage status is unused and prohibits use of the benefit (benefit code) when the usage status is used. That is, when the status S value in the benefit record 721 including the benefit code detected by the detection unit 616 is “0” (indicating unused), the control unit 618 outputs, to the payment machine 10 that sent the benefit code, a signal for permitting complimentary processing of a complimentary coupon identified by the benefit code. When the status S value in the benefit record 721 including the benefit code detected by the detection unit 616 is “1” (indicating used), the control unit 618 outputs, to the payment machine 10 that sent the benefit code, a signal for not allowing complimentary processing of a complimentary coupon identified by the benefit code. Alternatively, the control unit 618 simply does not output a signal for allowing complimentary processing. The payment machine 10 that receives a signal for permitting the complimentary processing of the complimentary coupon executes the complimentary processing via the processing unit 414.

The functions of the acquisition unit 611, the update unit 612, the provision unit 613, the generation unit 614, and the storage unit 615 are implemented by first information processing executed by the processor 61 according to a first software program or the like. The functions of the detection unit 616, the changing unit 617, and the control unit 618 are implemented by second information processing executed by the processor 61 according to a second software program or the like.

These programs can be application programs or the like stored in the main memory 62 or the auxiliary storage device 63. The method of installing or loading these programs in the main memory 62 or the auxiliary storage device 63 is not particularly limited. These programs can be recorded on a removable recording medium or t distributed by communication via the communication network 30. The recording medium may be in any non-transitory format as long as it can store programs and is readable by a computer, such as a CD-ROM or a memory card. The first program and the second program may be separate programs or may be an integrated program.

### Description of First Information Processing

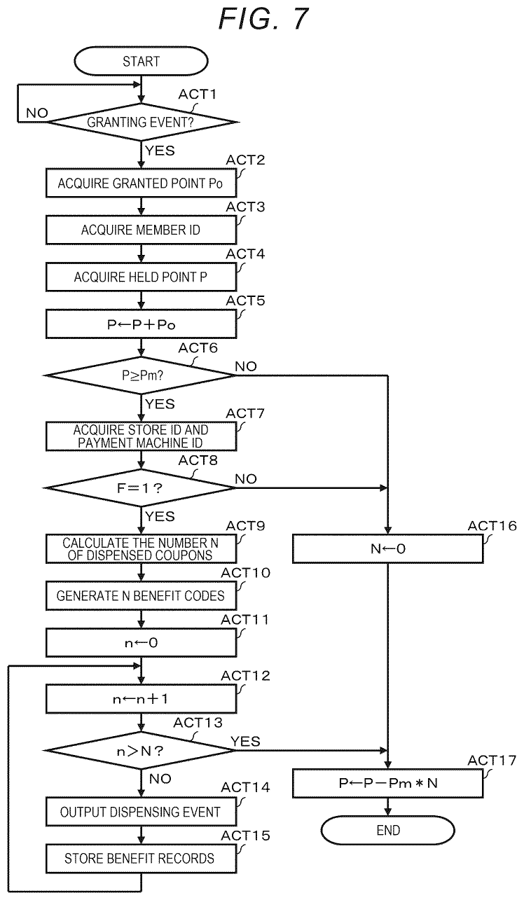

FIG. 7 is a flowchart of first information processing executed by the processor 61 of the point management server 20. The content and procedure of the information processing described below are exemplary. The content and the procedure can be appropriately changed as long as the same effects can be achieved.

In ACT 1, the processor 61 waits for a granting event. When the function of the granting unit 411 is activated in the first payment machine 101 or the second payment machine 102, a granting event notice including a granted point, a member ID, a store ID, a payment machine ID, a transaction number, and the like is output to the point management server 20. After receiving the granting event notice via the communication interface 45, the processor 61 proceeds from ACT 1 to ACT 2. In ACT 2, the processor 61 acquires a granted point Po for the granting event. In ACT 3, the processor 61 acquires the member ID for the granting event.

The processor 61 then proceeds to ACT 4. In ACT 4, the processor 61 searches the member database 71 and acquires a held point P value from the member record 711 matching the acquired member ID. Then, the processor 61 adds the newly acquired granted point Po to the held point P to update the held point P value.

After updating the held point P, the processor 61 proceeds to ACT 6. In ACT 6, the processor 61 checks whether the updated held point P meets a provision condition point Pm. The provision condition point Pm is a point level or the like that satisfies a benefit provision condition. That is, in the present example in which the benefit permission condition is “a price reduction coupon of 500 yen is dispensed each time the held point P reaches 500 points”, the provision condition point Pm is a threshold value of 500 points.

If the held point P is less than this provision condition point Pm, the processor 61 proceeds to ACT 16. The processing after ACT 16 will be described later.

If the held point P value meets the provision condition point Pm, the processor 61 proceeds to ACT 7. In ACT 7, the processor 61 acquires the store ID and the payment machine ID from the granting event notice. Then, in ACT 8, the processor 61 searches the store table 73 and checks whether the type flag F corresponding to the store ID and the payment machine ID is “1”. If the type flag F is “0”, that is, the payment machine 10 specified by the store ID and the payment machine ID is a second payment machine 102, the processor 61 proceeds to ACT 16.

On the other hand, if the type flag F is “1”, that is, the payment machine 10 specified by the store ID and the payment machine ID is a first payment machine 101, the processor 61 proceeds to ACT 9. In ACT 9, the processor 61 calculates the number N of dispensed complimentary coupons to be dispensed. That is, in the present example in which the benefit permission condition is “a price reduction coupon of 500 yen is dispensed each time the held point P reaches 500 points”, the number N of dispensed coupons is an integer multiple obtained by dividing the held point P by the provision condition point Pm and ignoring the remainder.

After calculating the number N of dispensed coupons, the processor 61 proceeds to ACT 10. In ACT 10, the processor 61 generates benefit codes corresponding to each of the dispensed coupons. For example, a year, month, and date tracked by the timepiece 64, the store ID, the payment machine ID, and the transaction number included in the granting event notice, and consecutive numbers from “1” to the number N of dispensed coupons are combined to generate the unique benefit codes for each of the dispensed coupons. The generated benefit codes are unique numbers since the consecutive numbers are different. Assuming that the year, month, and date are 6 digits in total: 2 digits for the year, 2 digits for the month, and 2 digits for the date, the store ID and the payment machine ID are each 3 digits, and the transaction number and the consecutive number are each 4 digits, the benefit code can be a 20-digit number string.

After generating the benefit codes, the processor 61 proceeds to ACT 11. In ACT 11, the processor 61 resets the dispensing counter n to “0”. Next, in ACT 12, the processor 61 counts up the dispensing counter n by “1”. Then, in ACT 13, the processor 61 checks whether the dispensing counter n exceeds the number N of dispensed coupons.

Initially, since the number N of dispensed coupons is “1” or more, the dispensing counter n does not exceed the number N of dispensed coupons. The processor 61 proceeds to ACT 14. In ACT 14, the processor 61 outputs a dispensing event notice to the payment machine 10 that sent the granting event notice. The dispensing event notice instructs dispensing of a complimentary coupon. The dispensing event includes a benefit code including a value of the dispensing counter n as a consecutive number. That is, when the dispensing counter n is “1”, a benefit code having a 4-digit consecutive number of “0001” is included. The processor 61 outputs the dispensing event from the communication interface 65 with the store ID and the payment machine ID included in the granting event notice.

After outputting the dispensing event notice, the processor 61 proceeds to ACT 15. In ACT 15, the processor 61 stores the benefit record 721 including the benefit code, the provision date, and the status S included in the dispensing event in the benefit database 72. At this time, the status S is a value indicating an unused status, that is, “0”.

After saving the benefit record 721, the processor 61 returns to ACT 12. Then, the processor 61 executes the processing after ACT 12 in the same manner as described above. Therefore, if the number N of dispensed coupons is “2” or more, the processor 61 repeats the processing of ACT 14 and ACT 15 N times. As a result, dispensing event notices are output to the payment machine 10 for each of the number N of dispensed coupons. The benefit records 721 including the benefit code, the provision date, and the status S included in the dispensing event notice(s) are sequentially stored in the benefit database 72.

In ACT 13, if the dispensing counter n exceeds the number N of dispensed coupons, the processor 61 proceeds ACT 17.

If the held point P is less than the provision condition point Pm in ACT 6 or if the type flag F is “0” in ACT 8, the processor 61 proceeds to ACT 16. In ACT 16, the processor 61 sets the number N of dispensed coupons to “0”. Then, the processor 61 proceeds to ACT 17.

If the number N of dispensed coupons is set to “0” in ACT 16 (or if the dispensing counter n exceeds the number N of dispensed coupons in ACT 13), the processor 61 proceeds to ACT 17. In ACT 17, the processor 61 calculates the held point P using the following equation (1):

P=P−Pm*N Equation (1)

That is, the processor 61 subtracts the points obtained by multiplying the provision condition point Pm by the number N of dispensed coupons from the held point P. Thus, the processor 61 ends the first information processing.

Here, the processor 61 implements the functions of the acquisition unit 611 in the processing of ACT 1 and ACT 2. The processor 61 implements the functions of the update unit 612 in the processing of ACT 3 to ACT 5. The processor 61 implements the functions of the generation unit 614 in the processing of ACT 10. The processor 61 implements the functions of the provision unit 613 in the processing of ACT 14. The processor 61 implements the functions of the storage unit 615 in the processing of ACT 15.

As described above, in a point management server 20 that receives a granting event notice from a payment machine 10, the first information processing is executed. As a result, the held point P of the member specified by the member ID included in the granting event notice is updated by adding the granted point Po included in the granting event notice. If the held point P value after the update meets the provision condition point Pm, the further processing procedure depends on whether the payment machine 10 that sent the granting event notice is a first payment machine 101 (first-type payment machine) or a second payment machine 102 (second-type payment machine).

If the payment machine 10 is the first payment machine 101, the number N of dispensed coupons will be calculated. Then, dispensing events corresponding to the number N of dispensed coupons will be output to the first payment machine 101. The benefit record 721 will be stored in the benefit database 72 for each benefit code corresponding to the dispensing event. Furthermore, the held point P value is reduced by the point value obtained by multiplying the provision condition point Pm by the number N of dispensed coupons.

On the other hand, if the payment machine 10 is a second payment machine 102, the dispensing event notice is not output. The held point P value is thus not reduced since no coupons/benefits are provided at this time.

Incidentally, in the first payment machine 101, the function of the dispensing unit 412 is activated each time a dispensing event notice is received. As a result, complimentary coupons having different benefit codes can be dispensed for each of the dispensing event notices.

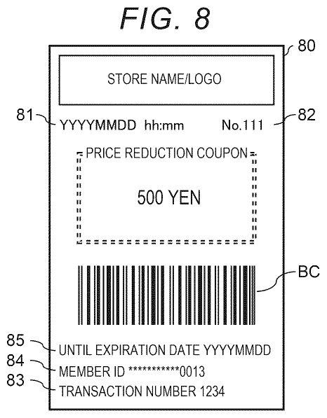

FIG. 8 is an example of a complimentary coupon issued when the benefit permission condition is “a price reduction coupon of 500 yen is dispensed each time the held point P reaches 500 points”. That is, the complimentary coupon is a price reduction coupon 80 which reduces a sales transaction total by 500 yen when applied. On the price reduction coupon 80, a transaction date and time 81, a terminal ID 82, and a transaction number 83 are printed in addition to a store name and a logo similarly to a normal purchase receipt. A member ID 84 and an expiration date 85 for the complimentary coupon are also printed on the price reduction coupon 80. Further, a barcode BC is printed on the price reduction coupon 80. The barcode BC encodes a benefit code corresponding to a dispensing event.

A member who obtains such a price reduction coupon 80 can receive a price reduction of 500 yen by presenting the price reduction coupon 80 at the time of payment in a sales transaction at a directly managed store or tenant store in the commercial facility SC. That is, in the first payment machine 101 of a directly managed store or the second payment machine 102 of a tenant store, when the barcode BC of the price reduction coupon 80 is scanned by the scanner 53, the reading unit 413 is activated, and a benefit event notice is transmitted from the first payment machine 101 or the second payment machine 102 to the point management server 20. The benefit event includes notice data of the barcode BC, that is, the benefit code of the presented price reduction coupon 80.

### Description of Second Information Processing

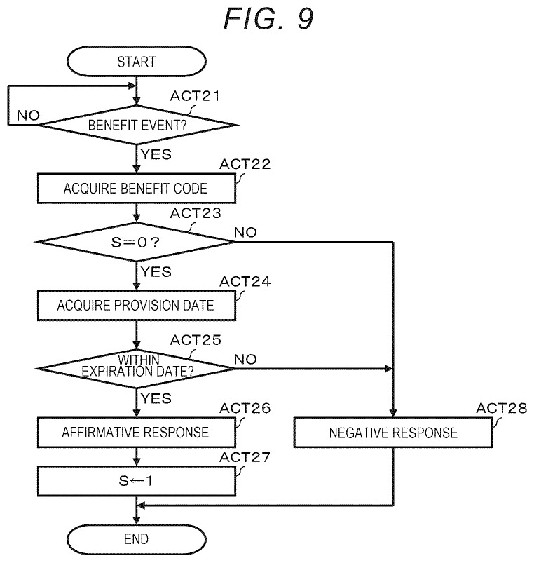

FIG. 9 is a flowchart of second information processing executed by the processor 61 of a point management server 20. The content and procedure of the information processing described below are exemplary. The content and the procedure can be appropriately changed as long as the same effect can be achieved.

In ACT 21, the processor 61 waits for a benefit event. After receiving a benefit event notice via the communication interface 45, the processor 61 proceeds from ACT 21 to ACT 22. In ACT 22, the processor 61 acquires a benefit code for the benefit event.

After acquiring the benefit code, the processor 61 proceeds to ACT 23. In ACT 23, the processor 61 searches the benefit database 72 for the entry corresponding to the just acquired benefit code. Then, the processor 61 checks the status S of a benefit record 721 matching the benefit code. If the status S indicates “0”, that is, an unused status, the processor 61 proceeds to ACT 24. In ACT 24, the processor 61 acquires a provision date from the benefit record 721. Then, in ACT 25, the processor 61 checks whether a current date (as tracked by the timepiece 64) is within the expiration date. For example, if the expiration date of a complimentary coupon is one year, the processor 61 checks whether the current date is still within one year from the provision date. Then, if the current date is within one year from the provision date, the processor 61 determines that the presented complimentary coupon is still within the expiration date (coupon is still valid). If the current date is already passed one year after the provision date, the processor 61 determines that the complimentary coupon is beyond the expiration date (coupon has expired).

If the complimentary coupon is within the expiration date, the processor 61 proceeds to ACT 26. In ACT 26, the processor 61 transmits an affirmative response to the payment machine 10 that sent the benefit event notice. In response to this affirmative response, the processing unit 414 is activated in the payment machine 10. That is, the processor 41 of the payment machine 10 reduces a subtotal amount of the transaction by 500 yen.

After transmitting the affirmative response, the processor 61 proceeds to ACT 27. In ACT 27, the processor 61 changes the status S of the benefit record 721 from “0” to “1”. That is, the status of the benefit specified by the benefit record 721 is changed from unused to used.

On the other hand, if the status S is “1” in ACT 23, that is, indicates the used status, or if the complimentary coupon is out of the expiration date in ACT 25, the processor 61 proceeds to ACT 28. In ACT 28, the processor 61 transmits a negative response to the payment machine 10. In the payment machine 10 that receives the negative response, the processing unit 414 is not activated. As described above, the status S can be “1” (the complimentary coupon that is used) or the expiration date may have passed for a complimentary coupon and thus such a coupon is invalid and cannot be used. Thus, the processor 61 ends the second information processing.

Here, the processor 61 implements the functions of the detection unit 616 in the processing of ACT 21 and ACT 22. The processor 61 implements the functions of the changing unit 617 in the processing of ACT 27. The processor 61 implements the functions of the control unit 618 in the processing of ACT 25 and ACT 28.

### Effects of Embodiment

In the commercial facility SC for which a point management system 100 including the point management server 20 is constructed, the following aspects of a point service can be implemented.
1. Points can be granted when a transaction with a member is settled by a first payment machine 101 or a second payment machine 102 at a directly managed store or a tenant store. The point management server 20 acquires the granted points from whatever transaction location and accumulates the points (as the held point P) for each member.
2. When a member reaches a held point P level meeting a provision condition point Pm and settles a transaction at a directly managed store, the point management server 20 controls such that a complimentary coupon is dispensed from the payment machine 10 (that is, a first payment machine 101) at the directly managed store. At this time, complimentary coupons can be dispensed as an integer multiple of the provision condition point PM (that is, as the quotient obtained by dividing the currently held point P by the provision condition point Pm).
3. The point management server 20 sets a unique benefit code for each of the complimentary coupons dispensed. The point management server 20 stores, in association with the unique benefit code of each of the complimentary coupons, the status S indicating whether the complimentary coupon is presently unused or used. The benefit code can be printed as a barcode on the complimentary coupon, for example.
4. When the barcode (the benefit code) of the complimentary coupon presented by a member is read by a first payment machine 101 or a second payment machine 102 at the time of payment at a directly managed store or a tenant store, the point management server 20 determines whether the complimentary coupon corresponding to the benefit code has been previously used. When the complimentary coupon has not yet been used, the point management server 20 outputs a signal for permitting execution of complimentary processing to the first payment machine 101 or the second payment machine 102. Then, the point management server 20 changes the status of the complimentary coupon to used. On the other hand, when the complimentary coupon has been previously used, the point management server 20 does not output a signal for permitting execution of complimentary processing. Therefore, unused complimentary coupons can be used, but already used complimentary coupons can no longer be used.

As described above, according to the first embodiment, it is possible to provide a point management server 20 permitting a convenient introduction of a point service in a commercial facility SC.

### Second Embodiment

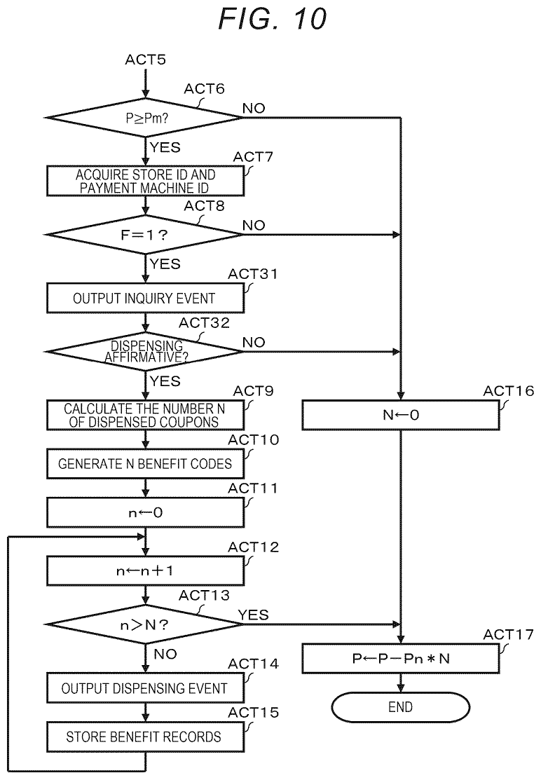

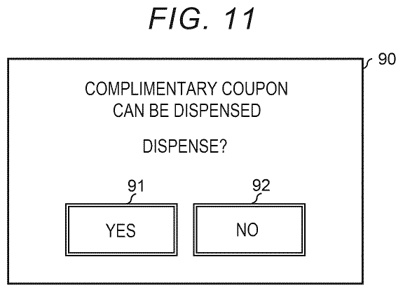

Next, a second embodiment will be described with reference to FIGS. 10 and 11.

In the first embodiment, when a member whose held point P values reaches the provision condition point Pm settles a transaction at a directly managed store, the point management server 20 controls such that a complimentary coupon is dispensed from the payment machine 10, that is, the first payment machine 101 of the directly managed store. However, it may be assumed that there may be members who do not like that a complimentary coupon is dispensed each time the held point P reaches the minimal provision condition point Pm. Therefore, in the second embodiment, an inquiry is made as to whether a complimentary coupon should be dispensed to the members whose held point P value reaches the provision condition point Pm. Complimentary coupons are dispensed only to those members who want the complimentary coupons to be dispensed. Complimentary coupons are not dispensed to those members who do not want the complimentary coupon(s) to be dispensed, and the member's held point P value is simply carried forward.

The second embodiment is different from the first embodiment in a part of first information processing executed by the processor 61 of the point management server 20. Since the second embodiment is otherwise similar to the first embodiment other than that aspect, aspects of the first embodiment described in conjunction with FIGS. 1 to 6, 8, and 9 can be considered to also apply to the second embodiment unless otherwise noted.

FIG. 10 is a flowchart of first information processing executed by the processor 61 of the point management server 20 in a second embodiment. Portions of the information processing common to the first embodiment (shown in FIG. 7) are given the same reference symbols.

As shown in FIG. 10, the second embodiment is different from the first embodiment in the processing after the searching of the store table 73 by the store ID and the payment machine ID acquired in the processing of ACT 7 and the confirming that the type flag F is “1” in ACT 8. In particular, in ACT 31, the processor 61 outputs an inquiry event notice to the first payment machine 101 that sent granting event notice. The inquiry event notice is for inquiring whether to dispense a complimentary coupon.

In a first payment machine 101 that receives the inquiry event notice, an inquiry screen 90 (see FIG. 11) is displayed on the display 47.

FIG. 11 is an example of an inquiry screen 90. The inquiry screen 90 is a screen on which a first button 91 for giving an instruction to dispense a complimentary coupon and a second button 92 for declining the dispensing of a complimentary coupon are arranged together with a message indicating that a complimentary coupon can be dispensed if desired. After checking the inquiry screen 90, a store clerk asks a member whether to dispense a complimentary coupon. Then, if the member wants the complimentary coupon(s), the store clerk selects the first button 91. If the member does not want the complimentary coupon at this time, the store clerk selects the second button 92. When the first button 91 is pressed, a dispensing affirmative signal is output from the first payment machine 101 to the point management server 20. When the second button 92 is pressed, a dispensing negative signal is output from the first payment machine 101 to the point management server 20. In some examples, the inquiry screen 90 may be displayed on a display for customers, and a customer may select the first button 91 or the second button 92 by himself/herself.

Returning to FIG. 10, after transmitting the inquiry event notice, the processor 61 of the point management server 20 proceeds to ACT 32. In ACT 32, the processor 61 waits to receive the dispensing affirmative signal or the dispensing negative signal from the first payment machine 101. After receiving the dispensing affirmative signal, the processor 61 proceeds from ACT 31 to ACT 9. Then, the processor 61 executes the processing of ACT 9 to ACT 15 and ACT 17 in the same manner as in the first embodiment. In accordance with this control, the first payment machine 101 dispenses complimentary coupons of the number N of dispensed coupons calculated based on the held point P and the provision condition point Pm.

On the other hand, when receiving the dispensing negative signal from the first payment machine 101, the processor 61 proceeds from ACT 31 to ACT 16. Then, the processor 61 executes the processing of ACT 16 and ACT 17 in the same manner as in the first embodiment. Therefore, no complimentary coupon is dispensed, and the held point P value of the member is maintained.

Thus, according to the second embodiment, a member whose held point P reaches the provision condition point Pm can select whether to dispense a complimentary coupon when settling a transaction at a directly managed store where the first payment machine 101 is installed. As a result, members can easily carry out operations such as dispensing complimentary coupons all at once as preferred.

### Other Embodiments

The content of the point service introduced in a multi-store commercial facility is not limited to the example described in the embodiments described above. For example, the benefit is not limited to a complimentary coupon. The benefit may be any benefit or reward that may be provided to a member by being printed on receipt paper using the printer 48 of a payment machine 10. In some examples, the benefit or reward may be provided at the payment machine 10 to a wireless communication medium presented by the customer or the like by using near range wireless communication. The wireless communication medium used in this context may be a non-contact type IC card, a smartphone, or the like.

In the embodiments described above, the payment machine 10 of a directly managed store is defined as a first payment machine 101 that has the dispensing unit 412, and the payment machine 10 of a tenant store is defined as a second payment machine 102 lacking a dispensing unit 412. However, in other examples, the payment machine 10 of the tenant store may be used as a first payment machine 101 as long as the payment machine 10 is the same model or otherwise compatible with a payment machine 10 of a directly managed store. Specifically, the type flag F in the store table 73 for such a payment machine 10 of a tenant store may be set to “1”.

In an embodiment, a benefit is provided when a transaction of a member whose held point P is greater than or equal to the provision condition point Pm is settled at a first payment machine 101. However, the earned benefit may be provided even if the member is not presently settling a transaction. For example, in addition to a mode for processing the settlement of a transaction in the first payment machine 101, another mode specialized for providing a benefit can be set. For example, a member ID may be acquired as identification information of a member at a first payment machine, and processing for transmitting a granting event including the member ID, a store ID, and a payment machine ID to the point management server 20 can be executed outside of a sales transaction settlement processing. The point management server 20 then executes the first information processing shown in FIG. 7 or FIG. 10. Thus, a member who shops at a tenant store without a first payment machine but whose held point P is greater than or equal to the provision condition point Pm may receive a benefit without having to purchase anything at a directly managed store where a first payment machine 101 is installed.

In an embodiment, the benefit provision condition is set to “a price reduction coupon of 500 yen is dispensed each time the held point P reaches 500 points”, and a case is exemplified where after N price reduction coupons of 500 yen are dispensed, [500*N] points are subtracted from the held point P and the remaining points of the held point P are retained. However, for the remaining points of the held point P, a price reduction coupon with a price reduction amount corresponding to the remaining points may be forced to be dispensed. For example, a price reduction coupon of 500 yen and a price reduction coupon of 200 yen may be dispensed to a member whose held point P is 700 points. In this case, a benefit code may be attached to the price reduction coupon of 500 yen to track whether it is unused or used, but no benefit code need necessarily be attached to the price reduction coupon of less than 500 yen. This can save the storage capacity of the benefit database 72.

While several embodiments have been described, the embodiments have been presented by way of example and are not intended to limit the scope of the exemplary embodiments. The novel embodiments can be implemented in various other forms, and various omissions, substitutions, and changes can be made in a scope not departing from the gist of the exemplary embodiments. The embodiments and modifications thereof are included in the scope of the exemplary embodiments, and are included in a scope of the exemplary embodiments disclosed in the claims and equivalents thereof.

What is claimed is:

1. A point management device for a multi-store commercial facility, the device comprising:
a communication interface configured to connect to a plurality of payment terminals in a plurality of stores; and
a processor configured to:
acquire notification of points granted to a member of a loyalty program for a transaction at a payment terminal in the plurality payment terminals;
update the points of the member based on the notification;
determine if the points of the member satisfy a benefit granting condition; and
when the points satisfy the benefit granting condition, send a benefit provision notification to the payment terminal if the payment terminal is a first-type terminal but not if the payment terminal is a second-type terminal.

2. The point management device according to claim 1, wherein the processor associates each benefit provision notification with a unique benefit code.

3. The point management device according to claim 2, wherein the processor is further configured to:
detect a benefit code in transaction data received from the plurality of payment terminals.

4. The point management device according to claim 3, wherein the processor is further configured to:
in response to detection of the benefit code, determine if the benefit code is associated with a usage status flag indicating the benefit code is valid, and if the usage status flag indicates the benefit code is valid, output a use permitted signal to the payment terminal that sent the transaction data including the benefit code.

5. The point management device according to claim 4, wherein, if the usage status flag indicates the benefit code is invalid, output a use-not-permitted signal to the payment terminal.

6. The point management device according to claim 4, wherein the processor is further configured to:
change the usage status flag associated with the detected benefit code from valid to invalid.

7. The point management device according to claim 1, wherein the benefit provision notification causes the payment terminal to print a coupon.

8. A point management system for a multi-store facility, the system comprising:
a plurality of payment terminals including a first-type payment terminal in a first-type store in a multi-store facility and a second-type payment terminal in a second-type store in the multi-store facility; and
a point management server including:
a communication interface connected to the plurality of payment terminals in the multi-store facility; and
a processor configured to:
acquire notification of points granted to a member of a loyalty program for a transaction at any payment terminal in the plurality payment terminals;
update the points of the member based on the notification;
determine if the points of the member satisfy a benefit granting condition; and
when the points satisfy the benefit granting condition, send a benefit provision notification to the payment terminal if the payment terminal is the first-type terminal but not if the payment terminal is the second-type terminal.

9. The point management system according to claim 8, wherein
the processor associates each benefit provision notification with a unique benefit code, and
the processor is further configured to:
detect a benefit code in transaction data received from the plurality of payment terminals.

10. The point management system according to claim 9, wherein the processor is further configured to:
in response to detection of the benefit code, determine if the benefit code is associated with a usage status flag indicating the benefit code is valid, and if the usage status flag indicates the benefit code is valid, output a use permitted signal to the payment terminal that sent the transaction data including the benefit code.

11. The point management system according to claim 10, wherein the processor is further configured to:
change the usage status flag associated with the detected benefit code from valid to invalid.

12. The point management system according to claim 8, wherein the benefit provision notification causes the payment terminal to print a coupon.

13. The point management system according to claim 8, wherein the first-type payment terminal has a different manufacturing than the second-type payment terminal.

14. The point management system according to claim 8, wherein
the first-type store is a store managed by an operator of the multi-store facility, and
the second-type store is a store managed an operator different than the first-type store.

15. The point management system according to claim 8, wherein the multi-store facility is a shopping mall.

16. A point management method for a multi-store facility including stores operated by different operators, the method comprising:
acquire notification of points granted to a member of a loyalty program for a transaction at a payment terminal in a plurality payment terminals of a multi-store facility;
updating the points of the member based on the notification;
determining if the points of the member satisfy a benefit granting condition; and
when the points satisfy the benefit granting condition, sending a benefit provision notification to the payment terminal if the payment terminal is a first-type terminal but not if the payment terminal is a second-type terminal.

17. The point management method according to claim 16, wherein the benefit provision notification causes the payment terminal to print a coupon.

18. The point management method according to claim 16, wherein
the first-type terminal is in a first-type store operated by an operator of the multi-store facility, and
the second-type terminal is a second-type store operated by an operator different from the first-type store.

19. The point management method according to claim 18, wherein the multi-store facility is a shopping mall.

20. The point management method according to claim 16, wherein
each benefit provision notification is associated with a unique benefit code, and
the method further comprises:
detecting a benefit code in transaction data received from the plurality of payment terminals.
